(19) United States
(12) Patent Application Publication
(10) Pub. No.: US 2012/0254518 A1
(43) Pub. Date: Oct. 4, 2012

(54) MEMORY SYSTEM

(75) Inventor: Yukio KOMATSU, Kanagawa-ken (JP)

(73) Assignee: Kabushiki Kaisha Toshiba, Minato-ku (JP)

(21) Appl. No.: 13/425,989

(22) Filed: Mar. 21, 2012

(30) Foreign Application Priority Data
Mar. 30, 2011 (JP) 2011-076442

(51) Int. Cl. G06F 12/02; G06F 12/00

(52) U.S. Cl. 711/103; 711/156; 711/E12.008; 711/E12.001

(57) ABSTRACT

A memory system includes: a plurality of word lines; a plurality of bit lines; a plurality of memory cells each having a control gate and a drain end, the control gate being connected to one of the word lines, the drain end being connected to one of the bit lines; a memory cell array including a plurality of blocks, each of the blocks including a plurality of pages, each of the pages being including a plurality of the memory cells; and a storage area configured to hold good block data identifying whether or not each of the blocks is a good block based on the number of fail bits in each page in the good block being less than or equal to a first threshold, wherein the first threshold is smaller than a second threshold used for identifying whether or not each of the blocks is a bad block.

### CROSS-REFERENCE TO RELATED APPLICATIONS

This application is based upon and claims the benefit of priority from the prior Japanese Patent Application No. 2011-076442, filed Mar. 30, 2011, the entire contents of which are incorporated herein by reference.

### FIELD

Embodiments described herein relate generally to memory system.

### BACKGROUND

In one of known methods for learning whether a memory cell is in a good or bad status from the outside, an address of a defective memory cell is written to a defective address detection circuit, and is outputted from the defective address detection circuit to a defective address output terminal if an address to be accessed matches the address of the defective memory cell. (see Japanese Patent Publication No. 4413406).

### BRIEF DESCRIPTION OF THE DRAWINGS

FIG. 1 is a block diagram showing an overall configuration of a memory system in a first embodiment.

FIG. 2 is a block diagram showing a configuration of a NAND flash memory in the first embodiment.

FIG. 3 is a diagram showing a circuit diagram of a memory cell array in the first embodiment.

FIG. 4A is a flowchart showing how the memory system in the first embodiment operates in a test process. FIG. 4B is a flowchart of step 1 in the first embodiment operates in a test process.

FIG. 5 is a flowchart showing how the memory system in the first embodiment operates in a writing sequence.

FIG. 6 is a graph showing a relationship between the number of fail bits in a block and the number of blocks.

FIG. 7 is a block diagram showing a good block address determination circuit in a memory system in a second embodiment.

FIGS. 8A and 8B-1, 8B-2 are diagrams each showing association between a table in the good block address determination circuit in the second embodiment and an operation of the memory system.

### DETAILED DESCRIPTION

Embodiments are described below by referring to the drawings. In the description, common parts are denoted by common reference numerals throughout the drawings. In addition, proportions of dimensions of the drawings are not limited to the proportions illustrated therein.

In general, according to one embodiment, a memory system includes: a plurality of word lines; a plurality of bit lines; a plurality of memory cells each having a control gate and a drain end, the control gate being connected to one of the word lines, the drain end being connected to one of the bit lines; a memory cell array including a plurality of blocks, each of the blocks including a plurality of pages, each of the pages being including a plurality of the memory cells; and a storage area configured to hold good block data identifying whether or not each of the blocks is a good block based on the number of fail bits in each page in the good block being less than or equal to a first threshold, wherein the first threshold is smaller than a second threshold used for identifying whether or not each of the blocks is a bad block.

It will be understood that when an element is referred to as being “electrically connected to” or “connected to” another element, it can be not only directly connected but also connected to the other element or intervening elements may be present.

### First Embodiment

### Memory System Configuration

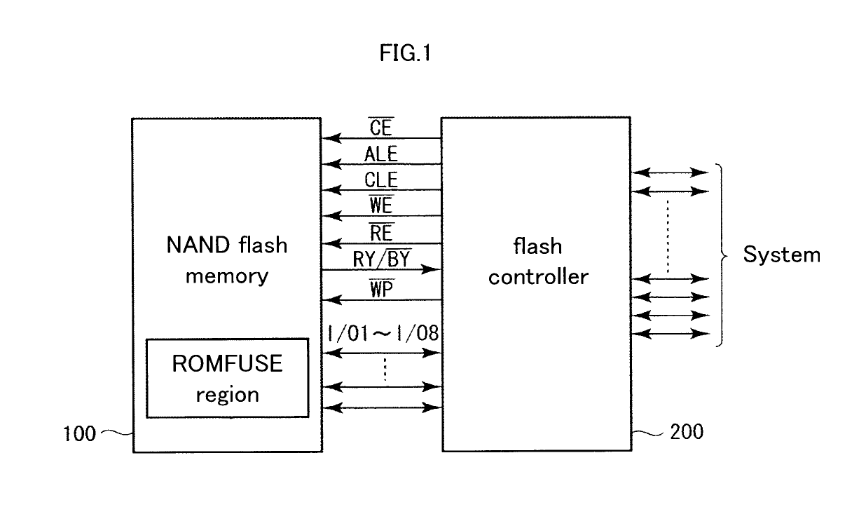

A configuration of a memory system of this embodiment will be described by using a block diagram in FIG. 1. As shown in FIG. 1, the memory system includes a NAND flash memory 100 and a flash controller 200. The flash controller 200 controls the NAND flash memory 100 based on a command received from, for example, a host system outside the memory system.

### <NAND Flash Memory>

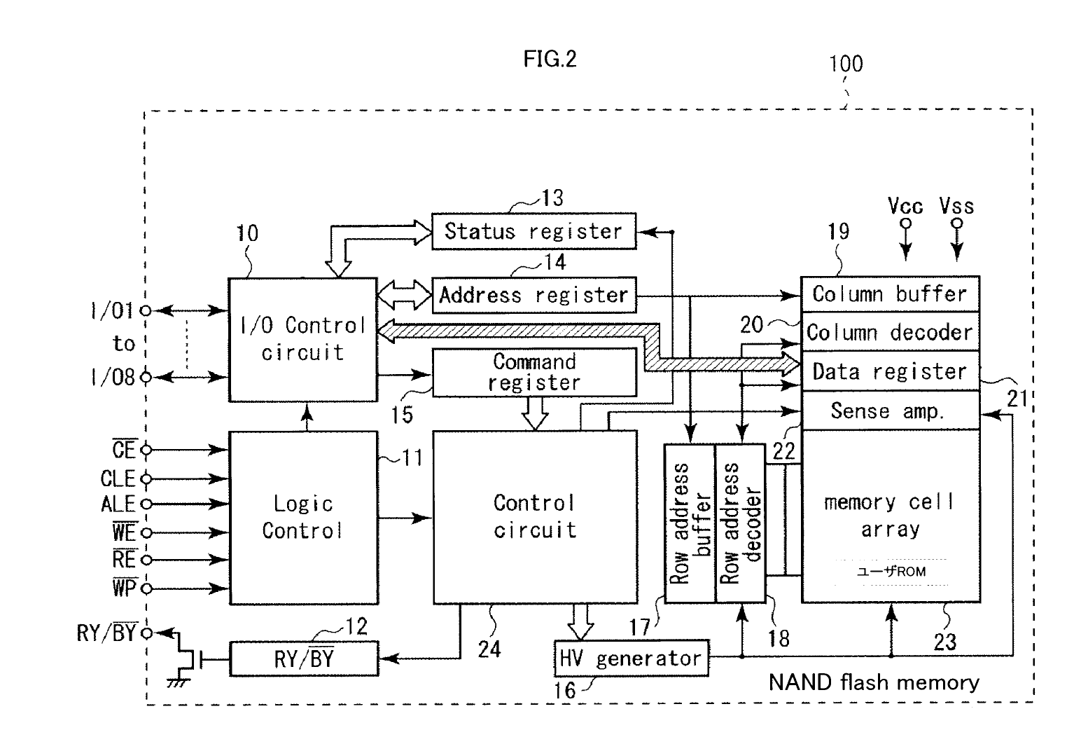

First of all, the NAND flash memory 100 will be described by using a block diagram in FIG. 2.

The NAND flash memory 100 includes: an input/output control circuit 10, a logic control circuit 11, a ready/busy control circuit 12, a status register 13, an address register 14, a command register 15, a high-voltage generator 16, a row address buffer 17, a row address decoder (also referred to as a row decoder) 18, a column buffer 19, a column decoder 20, a data register 21, a sense amplifier 22, a memory cell array 23, and a main control circuit 24.

### <<Input/Output Control Circuit>>

The input/output control circuit 10 has a function of controlling data input and output between the flash controller 200 and the NAND flash memory 100. The input/output control circuit 10 is electrically connected with the status register 13, the address register 14, the command register 15, and the data register 21. The input/output control circuit 10 transfers, to the command register 15, the address register 14, and the like, a command, an address, and the like inputted from the flash controller 200 through eight input/output terminals 101 to 108 shown in FIG. 1, for example.

The input/output control circuit 10 is controlled by various control signals inputted from the logic control circuit 11.

### <<Logic Control Circuit>>

The logic control circuit 11 is electrically connected with the input/output control circuit 10 and the main control circuit 24. The logic control circuit 11 receives various control signals of, for example, a chip enable signal /CE, an address latch enable signal ALE, a command latch enable signal CLE, a write enable signal /WE, a read enable signal /RE, a write protect signal /WP which are inputted from the flash controller 200, and controls the input/output control circuit 10 and the main control circuit 24 based on a combination of the signals.

### <<Ready/Busy Control Circuit>>

The ready/busy control circuit 12 is connected with the main control circuit 24, and receives a signal showing an operation status of the main control circuit 24. The ready/busy control circuit 12 receives the signal and outputs a ready/busy signal RY//BY (a BY-inverted signal) to the flash controller 200 based on the operation status (in a status of a write, a read, an erase or the like) of the main control circuit 24. For example, when the NAND flash memory 100 performs an internal operation such as the write, the read or the erase, the signal becomes RY//BY=“0” (busy). When the internal operation is completed, the signal becomes RY//BY=“1” (ready).

### <<Status Register>>

The status register 13 is electrically connected with the input/output control circuit 10 and the main control circuit 24. Upon activation (power on read) of the NAND flash memory 100, the status register 13 fetches various kinds of parameter information and the like stored in an ROMFUSE region (illustration omitted) in the memory cell array 23 and temporarily holds therein the information and the like.

### <<Address Register>>

The address register 14 is electrically connected with the input/output control circuit 10, the row address buffer 17, and the column buffer 19. The address register 14 temporarily holds therein an address inputted through the input/output control circuit 10 and transfers the address to the row address buffer 17 and the column buffer 19.

### <<Command Register>>

The command register 15 is electrically connected with the input/output control circuit 10 and the main control circuit 24. The command register 15 temporarily holds therein a command (a write command, a read command, an erase command, a status read command or the like) inputted through the input/output control circuit 10 and transfers the command to the main control circuit 24.

### <<High-Voltage Generator>>

The high-voltage generator 16 is electrically connected with the main control circuit 24. The high-voltage generator 16 generates a high voltage required in such an operation as the write, the read or the erase on the basis of the status of the main control circuit 24 and transfers the high voltage to the row decoder 18, the sense amplifier 22, and the memory cell array 23.

### <<Row Address Buffer>>

The row address buffer 17 is electrically connected with the address register 14 and the row address decoder 18. The row address buffer 17 temporarily holds therein a row address inputted from the address register 14 and transfers the row address to the row address decoder 18.

### <<Row Address Decoder>>

The row address decoder 18 is electrically connected with the row address buffer 17 and the memory cell array 23. The row address decoder 18 is connected with memory cells in the memory cell array 23 through word lines WL. The row address decoder 18 controls the word lines WL based on a row address inputted through the row address buffer 17. Specifically, the row address decoder 18 applies a voltage required for the write or read operation to a corresponding one of the word lines WL.

The row address decoder 18 includes multiple latch circuits. In a test (die sort) for determining whether or not a test target block is a bad block (hereinafter, referred to as a bad block test), each of the latch circuits holds binary data indicating whether or not the block is bad. For example, if the block is bad, the latch circuit holds data “1.” If the block is not bad, the latch circuit holds data “0.” When the bad block test is executed for each of multiple blocks, a corresponding one of the multiple latch circuits holds data on the block (indicating whether or not the block is bad).

Likewise, in a test (die sort) for determining whether or not a test target block is a good block (hereinafter, referred to as a good block test), the latch circuit holds binary data indicating whether or not the block is good. For example, the latch circuit holds the data “1” if the block is good, and holds “0” if the block is not good. The binary data indicating whether or not the block is bad is temporarily held in the latch circuit, and then stored in the ROMFUSE region. The binary data indicating whether or not the block is good is temporarily held in the latch circuit, and then stored in a user ROM region. Use of the different regions to store the data indicating whether or not the block is bad and the data indicating whether or not the block allows discrimination between these two kinds of data.

Note that when the bad block test is executed for each of multiple blocks, a corresponding one of the multiple latch circuits holds data (indicating whether or not the block is good) of the block.

### <<Column Buffer>>

The column buffer 19 is electrically connected with the address register 14 and the column decoder 20. The column buffer 19 temporarily holds therein a column address inputted through the address register 14 and transfers the column address to the column decoder 20.

### <<Column Decoder>>

The column decoder 20 is electrically connected with the column buffer 19 and the sense amplifier 22. The column decoder 20 has a function of controlling column selection by the sense amplifier 22.

### <<Data Register>>

The data register 21 is electrically connected with the input/output control circuit 10 and the sense amplifier 22. The data register 21 temporarily holds therein write data inputted from the input/output control circuit 10 or read data inputted from the sense amplifier 22.

The data register 21 has a function of holding: good block data (a good block is a block having “a” fail bits or less (“a” is an integer of 0 or larger) in each page of the block) in the good block test; and bad block data (a block having at least “b” (“b” is a natural number where a<b) fail bit in each page of the block) in the bad block test. The good block data is used for identifying whether or not each of the blocks is a good block. On the other hands, the bad block data is used for identifying whether or not each of the blocks is a bad block.

For example, data on the good block is binary data that takes “1” indicating that the block is good when the number of fail bits in each page of the block is “a” or smaller, or takes “0” indicating that the block is not good when the number of fail bits in any page of the block exceeds “a.” Note that the data on the good block also includes addresses of the blocks of “1” and “0.” Likewise, data on the bad block is binary data that takes “1” indicating that the block is bad when the number of fail bits in each page of the block is “b” or larger, or takes “0” indicating that the block is not bad when the number of fail bits in each page of the block is smaller than “b.” Note that the data on the bad block also includes addresses of the blocks of “1” and “0.”

### <<Sense Amplifier>>

The sense amplifier 22 is electrically connected with the column decoder 20, the data register 21, and the memory cell array 23. The sense amplifier 22 has a function of performing sensing operations for detecting a potential of one of bit lines BL and for reading data for verification after writing and erasing the data.

The sense amplifier 22 is connected to the memory cells in the memory cell array 23 through the bit lines BL. The sense amplifier 22 controls each bit line BL based on a corresponding column address inputted through the column decoder 20. Specifically, a voltage is selectively applied to the bit line BL in a write or read operation.

### <<Memory Cell Array>>

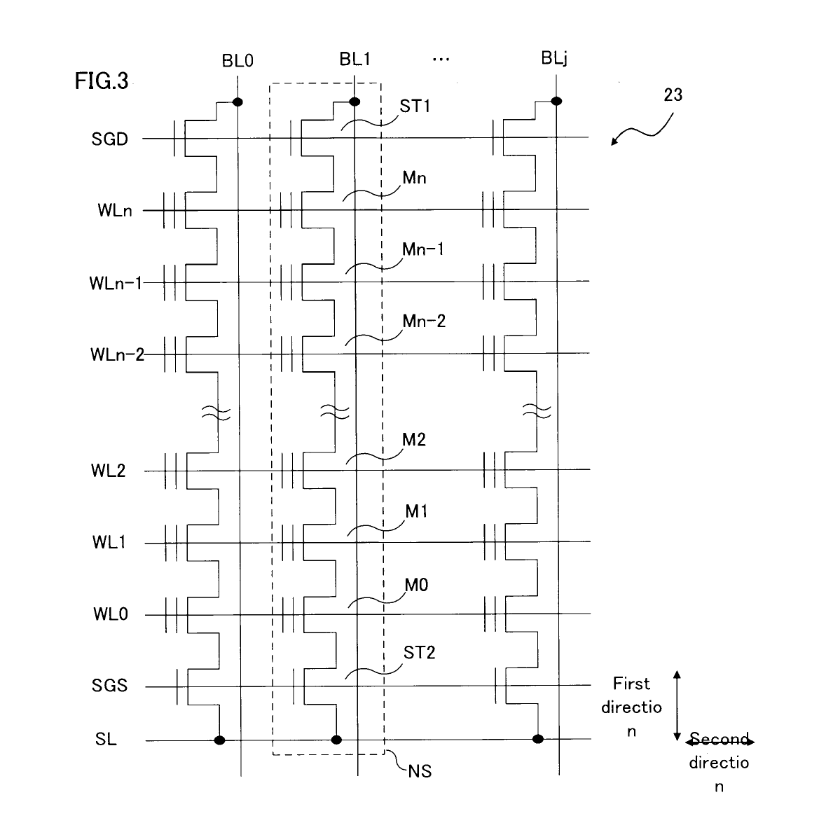

The memory cell array 23 is electrically connected with the row address decoder 18 and the sense amplifier 22. Here, the memory cell array 23 is described by using a circuit diagram in FIG. 3. As shown in FIG. 3, the memory cell array 23 includes multiple blocks (illustration omitted) including multiple non-volatile memory cells M0 to Mn. Each of the blocks includes multiple NAND strings NS arranged in a matrix form. Each of the NAND strings NS includes the multiple non-volatile memory cells M0 to Mn (the memory cells M0 to Mn are collectively referred to as memory cells M) and select transistors ST1, ST2. As shown in FIG. 3, (n+1) (n is an integer of 0 or larger) memory cells M0 to Mn are arranged between the select transistors ST1 and ST2 in such a manner that a current path thereof is connected in series. A drain region on a first end side of the memory cell Mn thus connected in series is connected to a source region of the select transistor ST1. A source region on a second end side of the memory cell M0 is connected to a drain region of the select transistor ST2. A source of one of the memory cells M also serves as a drain of a neighboring memory cell.

Each memory cell M can hold binary or higher-level data. The memory cell M has a MONOS structure including: a charge accumulating layer (for example, an insulating film) formed on a semiconductor substrate with a gate insulating film placed in between; an insulating film (having a higher dielectric constant than the charge accumulating layer) formed on the charge accumulating layer; and a control gate formed on the insulating film. Incidentally, the memory cell M may have a FG structure. The FG structure includes: a floating gate (a dielectric layer) formed on a p type semiconductor substrate with a gate insulating film placed in between; and a control gate formed on the floating gate with an inter-gate insulating film placed in between.

Control gates of the memory cells M0 to Mn are electrically connected to word lines WL0 to WLn, respectively, the drains thereof are electrically connected to the bit lines BL, respectively, and the sources thereof are electrically connected to a source line SL. The bit lines BL extend in a first direction (a direction in which the NAND strings NS extend) in FIG. 3 and are arranged above the NAND strings NS on a semiconductor substrate (illustration omitted). In contrast, the word lines WL0 to WLn extend in a second direction (a direction orthogonal to the first direction) and are arranged at regular intervals in the first direction.

The control gates of the memory cells M in the same row are connected in common to a corresponding one of the word lines WL0 to WLn. Gate electrodes of the select transistors ST1 for the memory cells M in the same row are connected in common to a select gate line SGD. Gate electrodes of the select transistors ST2 for the memory cells M in the same row are connected in common to a select gate line SGS. The select gate lines SGS, SGD are arranged in parallel with each other at ends of the word lines WL0 and WLn in such a manner as to sandwich the multiple word lines WL0 to WLn.

Meanwhile, in the memory cell array 23, a drain of the select transistor ST1 in each column is connected to a corresponding one of bit lines BL0 to BLj in the same column. Sources of the select transistors ST2 are connected in common to the source line SL.

Note that data is collectively written to the multiple memory cells M connected to the same word line WL, and a unit of the writing is referred to as a page. Further, the data is collectively erased in the memory cells M on a block BLK basis.

The memory cell array 23 includes the user ROM region (a storage region) and the ROMFUSE region. The user ROM region holds good block data, while the ROMFUSE region holds various parameter information at powering on and bad block data.

### [Memory System Operation]

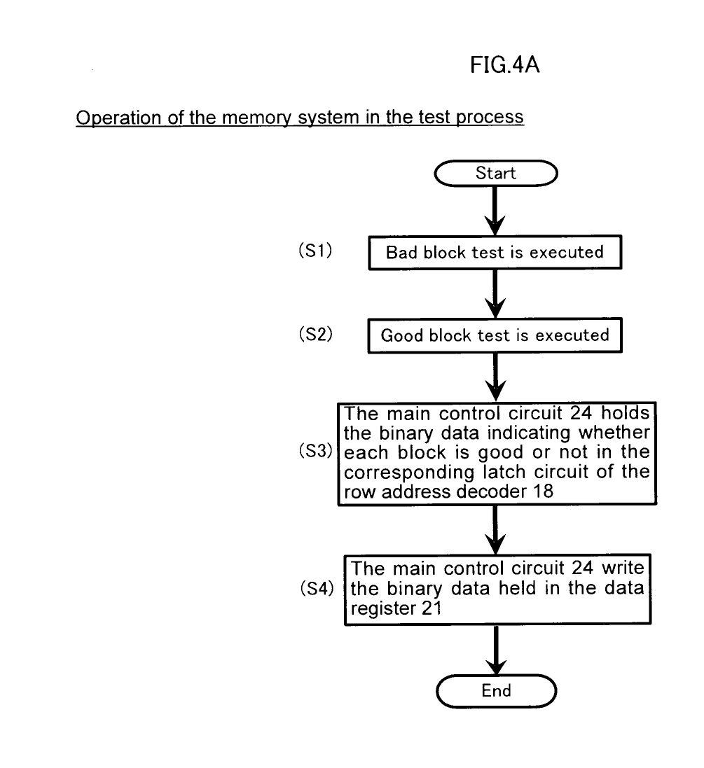

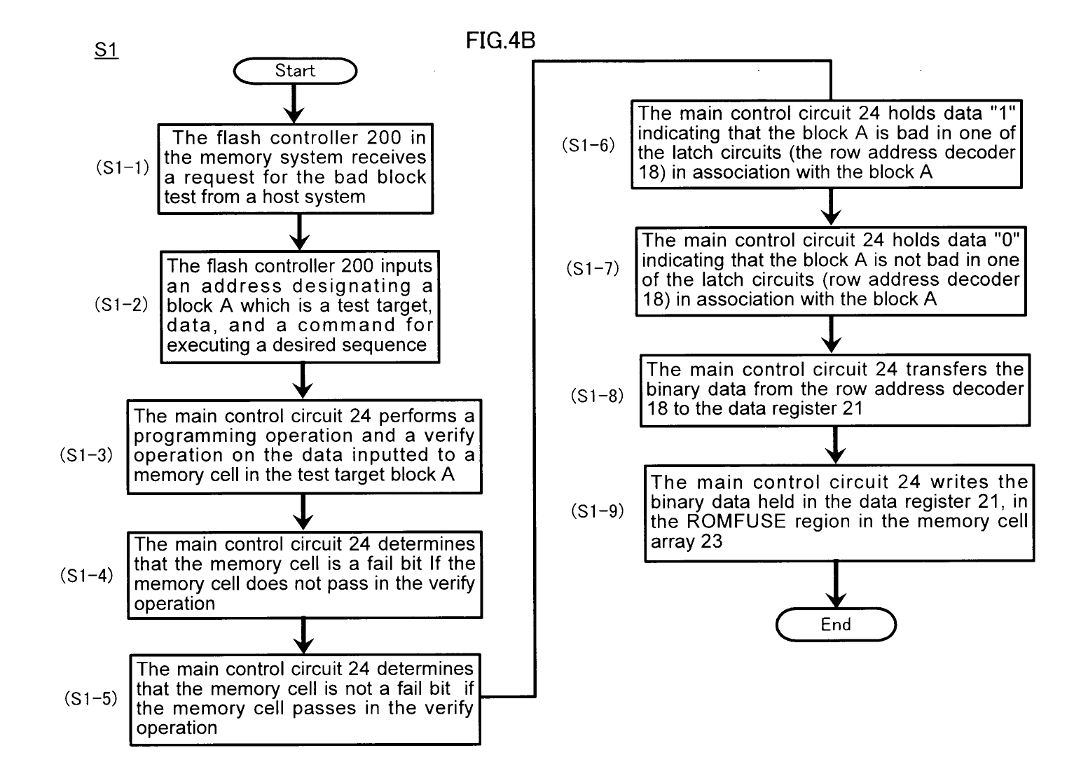

Next, how the memory system in this embodiment operates will be described by using flowcharts in FIGS. 4A, 4B and 5. Operations of the memory system in a test process and a data write sequence are described separately from each other for convenience sake.

### (1) Operation of the Memory System in the Test Process

As shown in FIG. 4A, firstly in Step S1, a bad block test for each block in the NAND flash memory 100 is executed.

Specifically, as shown in FIG. 4B, the flash controller 200 in the memory system receives a request for the bad block test from a host system (testing apparatus) (S1-1). The flash controller 200 inputs an address designating a block A which is a test target, data, and a command for executing a desired sequence (for example, a write command) to the input/output control circuit 10 of the NAND flash memory 100 (S1-2).

Based on the address, the data, and, for example, the write command which are inputted through the input/output control circuit 10, the main control circuit 24 of the NAND flash memory 100 controls the row decoder 18, the high-voltage generator 16, the column decoder 20, the data register 21, and the like so that the data can be written in the test target block A (S1-3). In other words, the main control circuit 24 performs a programming operation and a verify operation on the data inputted to a memory cell in the test target block A. The programming and verify operations are repeated until the memory cell passes in the verify operation.

If the memory cell does not pass in the verify operation even after the programming and verify operations are repeated desired times, the main control circuit 24 determines that the memory cell is a fail bit (S1-4). On the other hand, if the memory cell passes in the verify operation before the programming and verify operations are repeated desired times, the main control circuit 24 determines that the memory cell is not a fail bit (S1-5).

Then, the main control circuit 24 determines whether all the memory cells in every page in the block A are each a fail bit or not. Subsequently, if there is any page having “b” fail bits or more in the block A, the main control circuit 24 holds data “1” indicating that the block A is bad in one of the latch circuits (the row address decoder 18) in association with the block A (S1-6).

On the other hand, if there is any page having less than “b” fail bits in the block A, the main control circuit 24 holds data “0” indicating that the block A is not bad in one of the latch circuits (row address decoder 18) in association with the block A (S1-7). The main control circuit 24 performs the determination on every block, the determination being made as to whether or not there is any page having “b” fail bits or more in the block.

In other words, the main control circuit 24 holds the binary data indicating whether each block is bad or not in the corresponding latch circuit of the row address decoder 18.

The main control circuit 24 controls the row address decoder 18, the data register 21, and the like to transfer the binary data from the row address decoder 18 to the data register 21 (S1-8).

The main control circuit 24 controls the row decoder 18, the high-voltage generator 16, the column decoder 20, the data register 21, and the like to write the binary data held in the data register 21, in the ROMFUSE region in the memory cell array 23. Then, the processing in Step S1 ends (S1-9).

Next, in Step S2, a good block test for each block in the NAND flash memory 100 is executed. As in Step S1, the flash controller 200 in the memory system receives a request for the good block test from the host system (the testing apparatus). The flash controller 200 inputs an address designating a block B which is a test target, data, and a command for executing a desired sequence (for example, the write command) to the input/output control circuit 10 of the NAND flash memory 100.

Based on the address, the data, and, for example, the write command which are inputted through the input/output control circuit 10, the main control circuit 24 of the NAND flash memory 100 controls the row decoder 18, the high-voltage generator 16, the column decoder 20, the data register 21, and the like so that the data can be written in the test target block B. In other words, the main control circuit 24 performs the programming operation and the verify operation on the data inputted to a memory cell in the test target block B. The programming and verify operations are repeated until the memory cell passes in the verify operation. Note that the main control circuit 24 performs other various controls such as trimming of an initial program voltage VPGM, for example. For example, “Nonvolatile semiconductor memory capable of trimming an initial program voltage for each word line” in U.S. patent application Ser. No. 11/626,143 filed on Jan. 23, 2007 discloses the trimming, and is incorporated herein in its entirety.

If the memory cell does not pass in the verify operation even after the programming and verify operations are repeated desired times, the main control circuit 24 determines that the memory cell is a fail bit. On the other hand, if the memory cell passes in the verify operation before the programming and verify operations are repeated desired times, the main control circuit 24 determines that the memory cell is not a fail bit.

In Step S3, the main control circuit 24 determines whether all the memory cells in every page in the block B are each a fail bit or not. Subsequently, if there is any page having “a” fail bits or less in the block B, the main control circuit 24 holds data “1” indicating that the block B is good, in one of the latch circuits (the row address decoder 18) in association with the block B.

On the other hand, if there is any page having less than “a” fail bits in the block B, the main control circuit 24 holds data “0” indicating that the block B is not good, in one of the latch circuits (row address decoder 18) in association with the block B. The main control circuit 24 performs the determination on every block, the determination being made as to whether or not there is any page having “a” fail bits or less in the block.

In other words, the main control circuit 24 holds the binary data indicating whether each block is good or not in the corresponding latch circuit of the row address decoder 18.

The main control circuit 24 controls the row address decoder 18, the data register 21, and the like to transfer the binary data from the row address decoder 18 to the data register 21.

The main control circuit 24 controls the row decoder 18, the high-voltage generator 16, the column decoder 20, the data register 21, and the like to write the binary data held in the data register 21, in the user ROM region, which is different from the ROMFUSE region, in the memory cell array 23 (Step S4). Then, the processing ends.

### (2) Operation of the Memory System in the Data Writing Sequence

FIG. 5 is a flowchart showing how the memory system operates in a sequence of writing data (for example, management data) used for more important application than ordinary data, that is, data requiring higher reliability than ordinary data. In the description of the operation of the memory system in this operation, an operation of the memory system in writing ordinary data is omitted.

As shown in FIG. 5, firstly in Step S1, the flash controller 200 receives a request for writing data (particular data 1) used for important application, such as management data, and data (particular data 2) requiring higher reliability than ordinary data. Upon receipt of the writing request, an MPU (illustration omitted) of the flash controller 200 outputs a request for reading good block data stored in the user ROM region, to the NAND flash memory 100. At this time, the flash controller 200 issues a status command to the input/output control circuit 10.

In Step S2, upon receipt of the status command inputted through the input/output control circuit 10, the main control circuit 24 of the NAND flash memory 100 controls the row decoder 18, the high-voltage generator 16, the column decoder 20, the data register 21, and the like to load the data on the good block from the user ROM region of the memory cell array 23 to the sense amplifier 22.

In Step S3, the main control circuit 24 controls the sense amplifier 22 and the like so that the data on the good block can be outputted from the sense amplifier 22 to the data register 21 and then be outputted to the flash controller 200 through the input/output control circuit 10.

As the result, the MPU of the flash controller 200 holds the data on the good block in a RAM (illustration omitted) in the flash controller 200.

In Step S4, the MPU designates an address of a block registered as the good block and outputs a request (a command or the like) for writing particular data in the block, to the input/output control circuit 10 of the NAND flash memory 100.

In Step S5, the main control circuit 24 controls the row decoder 18, the high-voltage generator 16, the column decoder 20, the data register 21, and the like to write the particular data in the block registered as the good block.

### Advantageous Effects of First Embodiment

Accordingly, the embodiment can provide a memory system having improved reliability. Specific descriptions are given below.

A comparison is made between the memory system in this embodiment and a memory system in a comparative example. In the comparative example, it is determined whether or not blocks are bad, and the blocks determined not as bad blocks are used for a user region for storing ordinary data and a management region for storing management data.

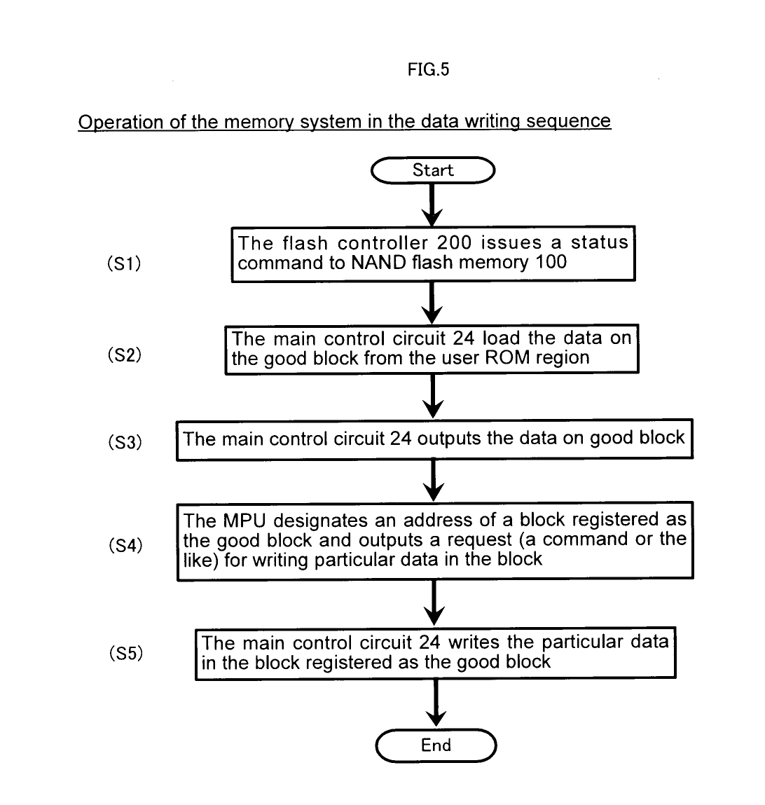

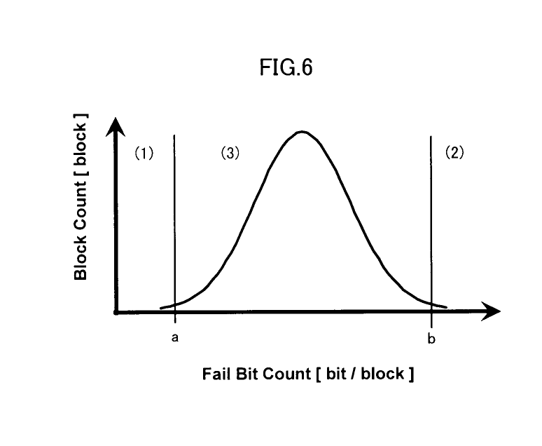

As shown in FIG. 6, the memory system in this embodiment classifies blocks into three types of good blocks, bad blocks, and the other blocks. In FIG. 6, a region (1) having less than “a” fail bits represents the good blocks, a region (2) having “b” fail bits or more represents the bad blocks, and a region (3) represents the other blocks.

Thus, the blocks shown in the region (3) can be used for a user region for holding ordinary data, and the good blocks shown in the region (1) can be used for a management region requiring higher reliability than the region for the ordinary data.

In the comparative example, the blocks determined not as good blocks (specifically, the blocks shown in the region (2) in FIG. 6) are used for the management region in some cases, and data retention might be deteriorated.

However, the memory system in this embodiment can use the good blocks for the management region and can hold particular data in a more reliable state than in the comparative example. Thus, this embodiment can provide a memory system having improved reliability.

In this embodiment, good blocks are used for the management region. However, memory systems include a memory system having a region for holding binary data and a region for holding multi-level data, and employing a method in which the memory system writes ordinary data by writing binary data in the region for holding the binary data and then writing multi-level data in the region for holding the multi-level data.

The concept of this embodiment may be applied to the memory system, and thereby good blocks may be used as the region for holding the binary data. In this case, it is possible to prevent deterioration of the data retention in the region for holding the binary data. Consequently, this embodiment can provide the memory system having improved data reliability.

Moreover, a modification can also be provided in which a good block test for a block registered as a bad block is not performed in the test process. Consequently, the test process can be speeded up.

### Second Embodiment

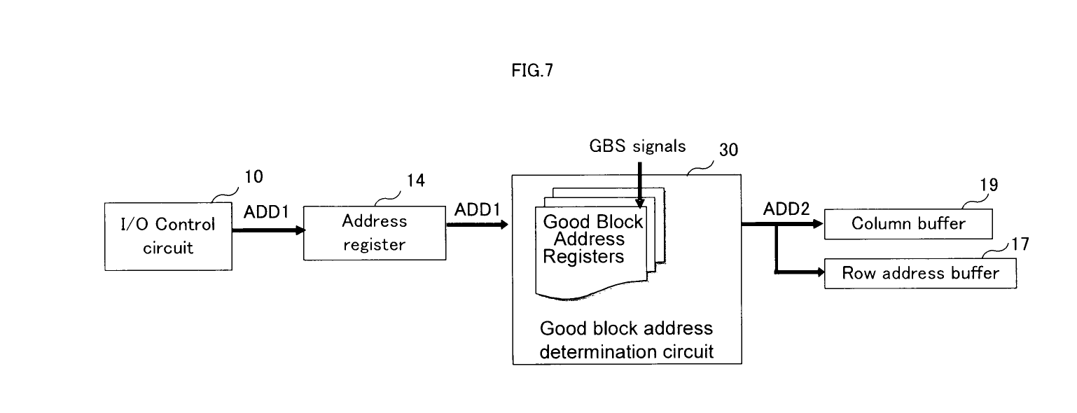

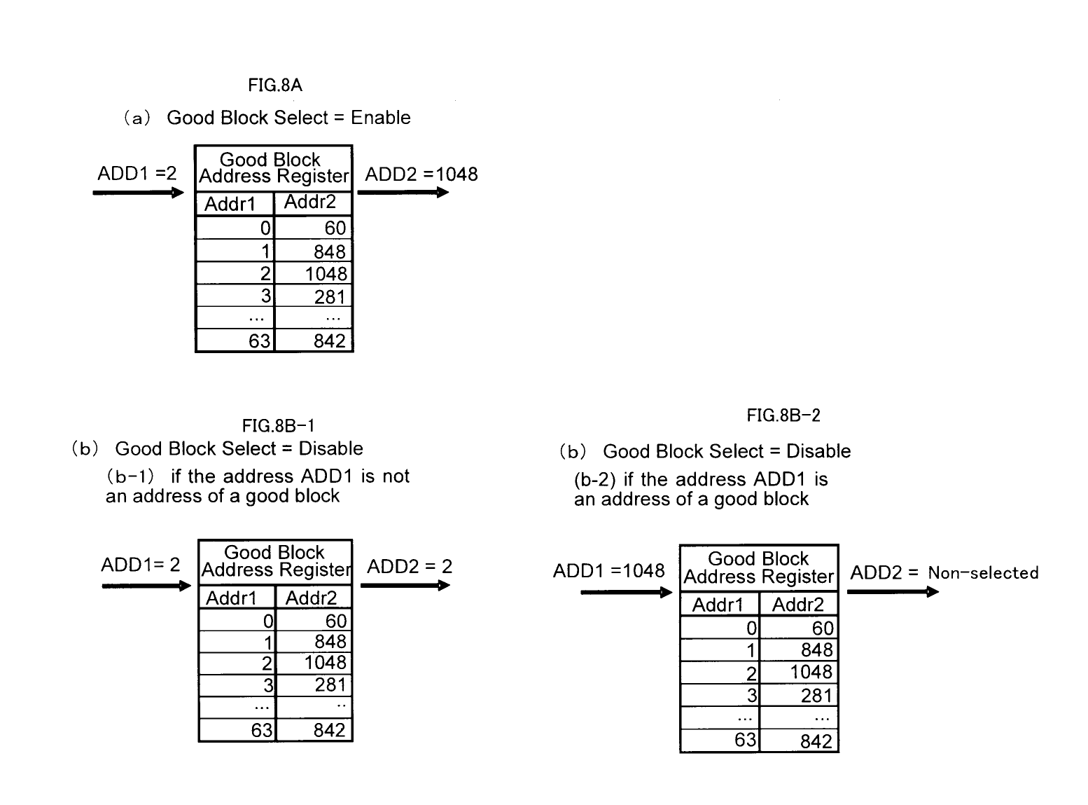

Next, a memory system in a second embodiment will be described by using FIG. 7 and FIGS. 8A and 8B. The memory system in the second embodiment is different from that in the first embodiment in that a good block address determination circuit 30 is provided to operate between the address register 14 and either the column buffer 19 or the row address buffer 17. The configuration of the other components in the second embodiment is the same as that in the first embodiment, a detailed description thereof will be omitted.

The good block address determination circuit 30 holds a table showing correspondence between an address inputted in the good block address determination circuit 30 and an address of a block registered as a good block. When turning active, the good block address determination circuit 30 outputs a block address of a good block corresponding to the inputted address based on a good block select (GBS) signal inputted from the main control circuit 24.

The good block address determination circuit 30 receives a GBS signal from the main control circuit 24.

It is conveniently assumed that when an inputted block address ADD1=2, a corresponding good block address ADD2=1048. The correspondence is held in the good block address determination circuit 30.

When receiving the address ADD1 (for example, ADD1=2) in a state where the GBS signal is asserted (the good block address determination circuit 30 is active) as shown in FIG. 8A, the good block address determination circuit 30 outputs the good block address ADD2 (ADD2=1048) corresponding to the address ADD1 to the row address buffer 17 or the column buffer 19. As the result, it is possible to execute an operation of, for example, writing data in the selected good block.

In other words, when detecting data inputted to the NAND flash memory 100 as, for example, particular data, the main control circuit 24 can assert a GBS signal and execute an operation of writing data in a selected good block.

Suppose a case where the good block address determination circuit 30 receives the address ADD1 (for example, ADD1=2) in a state where the GBS signal is negated (the good block address determination circuit 30 is inactive). In this case, if the address ADD1 is not an address of a good block, the good block address determination circuit 30 outputs the address ADD1 to the row address buffer 17 or the column buffer 19 (see FIG. 8B-1) without any special operation.

On the other hand, if the address ADD1 is an address of a good block, the good block address determination circuit 30 does not output a signal to the address ADD1 to the row address buffer 17 or the column buffer 19 (see FIG. 8B-2), so that no memory cell is selected. That is, no address of a good block is selected in the state where the GBS signal is negated.

Therefore, the memory system in this embodiment can also provide a memory system having improved reliability, like the first embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a plurality of word lines;
a plurality of bit lines;
a plurality of memory cells each having a control gate and a drain end, the control gate being connected to one of the word lines, the drain end being connected to one of the bit lines;
a memory cell array including a plurality of blocks, each of the blocks including a plurality of pages, each of the pages being including a plurality of the memory cells; and
a storage area configured to hold good block data identifying whether or not each of the blocks is a good block based on the number of fail bits in each page in the good block being less than or equal to a first threshold, wherein
the first threshold is smaller than a second threshold used for identifying whether or not each of the blocks is a bad block.

2. The memory system according to claim 1, wherein the storage region is a user ROM region in the memory cell array.

3. The memory system according to claim 1, further comprising a main control circuit configured to determine whether or not the number of fail bits in each page in a test target block is the first threshold or smaller than the first threshold in a test for identifying whether or not each of blocks is a good block.

4. The memory system according to claim 2, wherein when the number of fail bits in all the pages in the test target block is the first threshold or smaller than the first threshold, the main control circuit registers the test target block as the good block in the storage region.

5. The memory system according to claim 2, wherein when the number of fail bits in at least one page in the test target block exceeds the first threshold, the main control circuit registers the test target block as not being a good block in the storage region.

6. The memory system according to claim 1, wherein
the plurality of word lines, the plurality of bit lines, the memory cell array, and the storage region are provided in a semiconductor memory,
the memory system further comprises a flash controller configured to control the semiconductor memory, and
the good block data is loaded to the flash controller in a write operation.

7. The memory system according to claim 3, wherein
the plurality of word lines, the plurality of bit lines, the memory cell array, and the storage region are provided in a semiconductor memory,
the memory system further comprises a flash controller configured to control the semiconductor memory, and
the good block data is loaded to the flash controller in a write operation.

8. The memory system according to claim 4, wherein
the plurality of word lines, the plurality of bit lines, the memory cell array, and the storage region are provided in a semiconductor memory,
the memory system further comprises a flash controller configured to control the semiconductor memory, and
the good block data is loaded to the flash controller in a write operation.

9. The memory system according to claim 6, wherein when first data requiring higher reliability than ordinary data is written to the memory cell array, the flash controller controls the semiconductor memory so that the first data is written to the good block.

10. The memory system according to claim 7, wherein when first data requiring higher reliability than ordinary data is written to the memory cell array, the flash controller controls the semiconductor memory so that the first data is written to the good block.

11. The memory system according to claim 8, wherein when first data requiring higher reliability than ordinary data is written to the memory cell array, the flash controller controls the semiconductor memory so that the first data is written to the good block.

12. The memory system according to claim 1, wherein
the memory cell array comprises a region for holding binary data and a region for holding multi-level data,
when executing a write operation of writing data in the region for holding the binary data and then writing data in the region for holding the multi-level data, the flash controller designates the good block as the region for holding the binary data.

13. The memory system according to claim 1, further comprising a flash controller configured to control the semiconductor memory, and
the flash controller is configured to control a write operation based at least in part on the good block data.

14. A memory system comprising:
a memory cell array including blocks each of which includes a plurality of pages each including a plurality of the memory cells; and
storage means for holding good block data i identifying whether or not each of the blocks is a good block based on the number of fail bits in each page in the good block being less than or equal to a first threshold, wherein
the first threshold is smaller than a second threshold used for identifying whether or not each of the blocks is a bad block.
